(19) United States
(12) Patent Application Publication
(10) Pub. No.: US 2016/0259544 A1
(43) Pub. Date: Sep. 8, 2016

(54) Systems And Methods For Virtual Periphery Interaction

(71) Applicants: Artem Polikarpov, St. Petersburg (RU); Mitch Brisebois, Ontario (CA); Alexander Kirillov, St. Petersburg (RU)

(72) Inventors: Artem Polikarpov, St. Petersburg (RU); Mitch Brisebois, Ontario (CA); Alexander Kirillov, St. Petersburg (RU)

(21) Appl. No.: 14/850,096

(22) Filed: Sep. 10, 2015

(30) Foreign Application Priority Data
Mar. 4, 2015 (RU) 2015107425

(51) Int. Cl. G06F 3/0488; G06F 3/041

(52) U.S. Cl. CPC G06F 3/04886; G06F 3/0412; G06F 3/0418; G06F 3/04883

(57) ABSTRACT

Systems and methods may be implemented to enable an information handling system to adjust touchscreen interaction with a user depending on how the user is holding or otherwise touching a touchscreen display device and/or depending on what functions or tasks the user is currently performing. For example, in one embodiment, an information handling system may include one or more processing devices configured to first interpret how a user is currently using a touchscreen display device of the information handling system, and then to automatically modify the touchscreen behavior based on this interpreted touchscreen use by providing an inactive virtual bezel area that in a context-aware manner ignores touch events in the inactive area.

This application claims priority to co-pending Russian patent application serial number 2015107425 filed on Mar. 4, 2015, the disclosure of which is incorporated herein by reference in its entirety for all purposes.

### FIELD OF THE INVENTION

This application relates to touch screen displays and, more particularly, to touch screen displays for information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Tablet computers are a type of information handling system that include a touch screen display that both displays information to a user and that accepts input via user touch interaction with the display screen. Conventional tablet computers are becoming larger and more multi-purpose by offering a larger range of possible user activities such as stationary screen full screen mode, as well as one-handed and two-handed user modes. This increasing range of possible user activities creates challenges for a one-size-fits-all touch screen interaction methodology. In particular, when a conventional tablet is held by both hands of a user, the user typically has a reasonable use of multi-touch input capability. However, when the tablet is held by only one hand of a user, interaction with the conventional touch screen device is limited. Environmental factors also impact the experience. Currently available conventional tablet computers have a fixed design with a fixed-width physical hardware frame around the screen. Different tablet computers have different physical hardware frames of different fixed width, depending on the manufacturer.

Currently, some manufacturers produce tablet computers having “slim” bezels, or that have no bezels at all. Such minimization or removal of bezel areas provides increased display screen space for the same (or smaller) device size, while at the same time increasing the chance that grabbing or holding the tablet computer will result in false touch events when fingers contact the touchscreen area. Touch screen interaction for a conventional tablet is dependent on the operating system (OS), e.g., Microsoft's dual mode.

### SUMMARY OF THE INVENTION

Systems and methods are disclosed herein that may be implemented to enable an information handing system to adjust touchscreen interaction with a user depending on how the user is holding a touchscreen display device and/or depending on what functions or tasks the user is currently performing. For example, in one embodiment, an information handling system may include one or more processing devices configured to first interpret how a user is currently using a touchscreen display device of the information handling system, and then to automatically modify the touchscreen behavior and/or virtual periphery interaction based on this interpreted touchscreen use by providing an inactive virtual bezel area in a context-aware manner that blocks or otherwise discounts or withholds touch events made in the virtual bezel area as user inputs for an operating system and applications of the information handling system. Thus, the disclosed systems and methods may be advantageously implemented in one embodiment to modify touchscreen and user interaction behavior based on specific tasks for which the touchscreen display device is currently being employed by a user, e.g., such as to provide operational management tools that are used in a mobile context and for given activities where one-handed and one-thumbed operation of the device is preferable and thus may be provided to the user once performance of one of the given activities is identified, e.g., by a processing device of the information handling system.

In one exemplary embodiment an interpretative processing layer or module may be provided between a touchscreen controller and an OS of the information handling system that is executing on a processing device of the information handling system. Such an interpretative processing layer or module may be configured to intercept user input actions to the touchscreen and to implement a dynamic screen-based frame that modifies the touchscreen display device behavior based on how the user is currently using the touchscreen display. For example, assuming a touchscreen display device having no hardware frame width or having a narrow hardware frame width that is present as very little (e.g., less than 2 centimeters) space between the external periphery of the interactive UI area of the display screen and the external outside edge of the physical frame of the device, a sustained higher-pressure gripping input (e.g., that exceeds a minimum sensed pressure threshold) on the display screen may be interpreted as a user currently gripping (e.g., holding) the device, either with one or two hands. This interpreted user-holding input to the display screen by a user's finger/s or other part(s) of the user's hand/s may be automatically discounted (i.e., ignored) as an OS interaction input from the user, and therefore not passed on to the OS by the interpretative layer. In a further exemplary embodiment, a gripping input may be so identified and then discounted as an OS interaction by filtering out or otherwise ignoring all user finger or other types of hand touches except for fingertip inputs that are identifiable by a specified or pre-defined maximum fingertip input surface area, biometrics and/or impulse parameters. All other finger and other types of hand touch inputs may be interpreted and classified as gripping inputs applied that are applied to an identified gripping area (e.g., such as a finger grip area) that is ignored for purposes of OS input.

The disclosed systems and methods may be implemented in one exemplary embodiment to resize the virtual frame or bezel of a touchscreen display device to fit the current use and/or preferences of an individual current user (e.g., which may be saved in a user profile of an individual user using Android, Windows 8 or other tablet or touchscreen user profile). For example, a user may be allowed to change the virtual frame width of a touchscreen display by: first placing a fingertip on the internal edge of a virtual frame to provide a sustained finger touch greater than a minimum sensed pressure threshold for a minimum amount of time, waiting a second to activate the resizing process, and then slipping the finger to the left or to the right to make the virtual frame thicker or thinner. Thus, the width of a virtual frame of a touchscreen may be resized width based on user input to fit the different preferences of different users. In one embodiment, one or more of the same characteristics used for determination of a gripping input described herein may also be employed to activate virtual bezel resizing when detected.

In another exemplary embodiment, a touchscreen user interface (UI) area may be rendered (e.g., automatically) in a manner that appears to “flow around” or bypass the currently identified and located gripping area/s, e.g., to provide a “liquid frame” or “liquid edge” virtual bezel area which may be implemented as part of an interaction system for multi-purpose mobile touchscreen devices. In a further embodiment, additional utility may be provided by adding one or more virtual “hot button” area/s or other type of special purpose virtual active user interface (UI) areas embedded within an inactive virtual bezel area around the currently-identified location of a gripping area. Such special purpose UI areas may be implemented to replicate common controls of an application currently executing on the information handling system. For example, a smartphone may be used for inventory counts by information technology (IT) staff by allowing a user to hold the smartphone with one hand and locate and scan asset bar codes on computer components using a camera of the smartphone. In such an embodiment, the disclosed systems and methods may be implemented to interpret a user's thumb or finger grip area that satisfies one or more designated requirements for a gripping input action on the display (e.g., using any of the gripping input identification characteristics described elsewhere herein), and to respond by providing a one-handed liquid edge on the touchscreen display such that the user may reach around difficult to reach areas within a rack storage installation or other type of multi-component computer installation. Additionally, a special purpose virtual active UI area such as a “scan” hot button area or other type of virtual UI area may be automatically placed in real time (or “on the fly”) within easy reach of the user's gripping thumb wherever it is identified to be currently gripping the touchscreen, e.g., just above the identified area of the user's thumb that is gripping the device whether or not the phone is currently being gripped in a right-handed or left-handed manner by the user.

In one respect, disclosed herein is an information handling system, including: at least one host processing device configured to produce video pixel data; a touchscreen display having an interactive user interface area configured to display images based on video display data and to produce touch input signals corresponding to areas of the interactive user interface that are touched by a user; and at least one second processing device coupled between the host processing device and the touchscreen display and configured to receive the video pixel data from the host processing device and to receive the touch input signals from the interactive user interface area of the touchscreen display, the second processing device being further configured to provide video display data to the touchscreen display that is based on the video pixel data received from the host processing device and to provide touch input data to the host processing device that is based on the touch input signals received from the touch screen. The second processing device may be configured to: segregate the interactive user interface area of the touchscreen display into at least one active user interface area and at least one separate virtual bezel area, receive touch input signals from the active user interface area and provide touch input data to the host processing device corresponding to touch input signals received from the touchscreen display that are representative of touched areas of the active user interface area, and receive touch input signals from the virtual bezel area and block touch input data to the host processing device corresponding to touch input signals received from the touchscreen display that are representative of touched areas of the virtual bezel area.

In another respect, disclosed herein is a method, including: displaying images based on video display data on a touchscreen display having an interactive user interface area, and producing touch input signals corresponding to areas of the interactive user interface that are touched by a user; producing video pixel data from at least one host processing device; receiving the video pixel data from the host processing device in at least one second processing device and receiving the touch input signals in the at least one second processing device from the interactive user interface area of the touchscreen display; using the second processing device to provide video display data to the touchscreen display that is based on the video pixel data received from the host processing device and to provide touch input data to the host processing device that is based on the touch input signals received from the touch screen; and using the second processing device to: segregate the interactive user interface area of the touchscreen display into at least one active user interface area and at least one separate virtual bezel area, receive touch input signals from the active user interface area and provide touch input data to the host processing device corresponding to touch input signals received from the touchscreen display that are representative of touched areas of the active user interface area, and receive touch input signals from the virtual bezel area and block touch input data to the host processing device corresponding to touch input signals received from the touchscreen display that are representative of touched areas of the virtual bezel area.

### BRIEF DESCRIPTION OF THE DRAWINGS

FIG. 1A illustrates a block diagram of an information handling system according to one exemplary embodiment of the disclosed systems and methods.

FIG. 1B illustrates a block diagram of a touch screen display according to one exemplary embodiment of the disclosed systems and methods.

FIG. 1C illustrates a block diagram of a touch screen display according to one exemplary embodiment of the disclosed systems and methods.

FIG. 2A illustrates virtual periphery control based on interpreted use of a touchscreen according to one exemplary embodiment of the disclosed systems and methods.

FIG. 2B illustrates virtual periphery control based on interpreted use of a touchscreen according to one exemplary embodiment of the disclosed systems and methods.

FIG. 2C illustrates virtual periphery control based on interpreted use of a touchscreen according to one exemplary embodiment of the disclosed systems and methods.

FIG. 2D illustrates virtual periphery control based on interpreted use of a touchscreen according to one exemplary embodiment of the disclosed systems and methods.

FIG. 3 illustrates methodology according to one exemplary embodiment of the disclosed systems and methods.

### DESCRIPTION OF ILLUSTRATIVE EMBODIMENTS

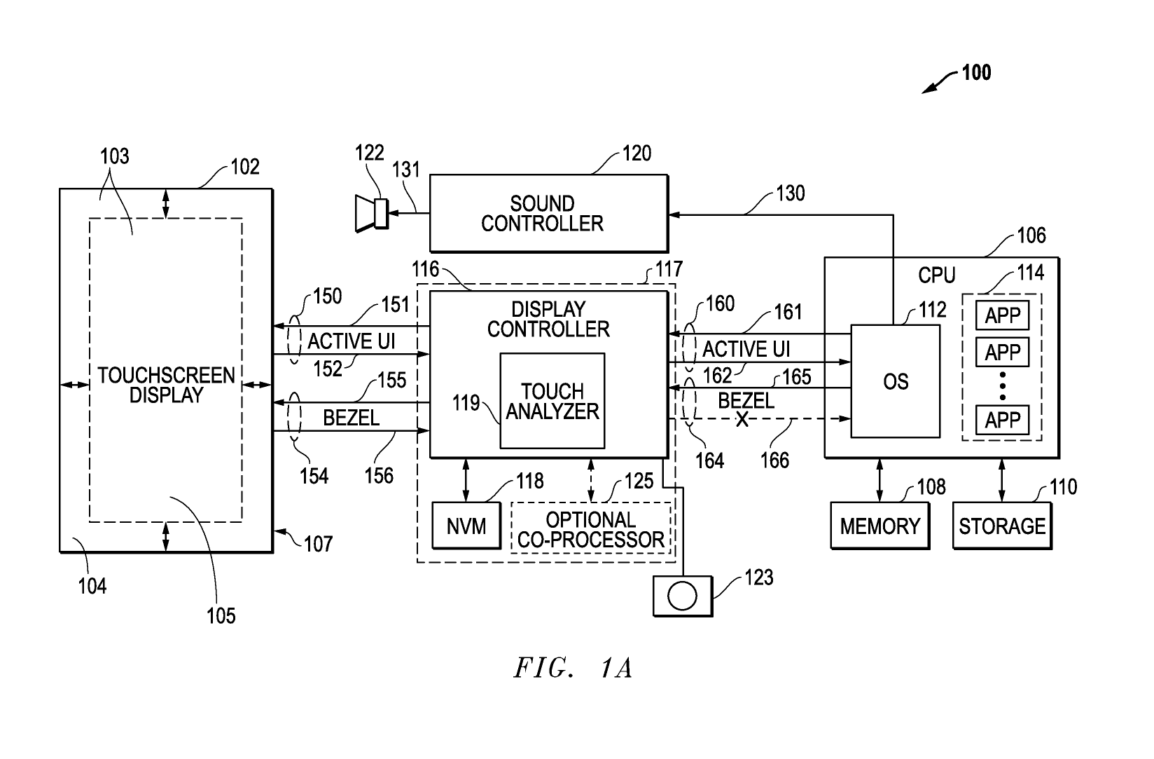

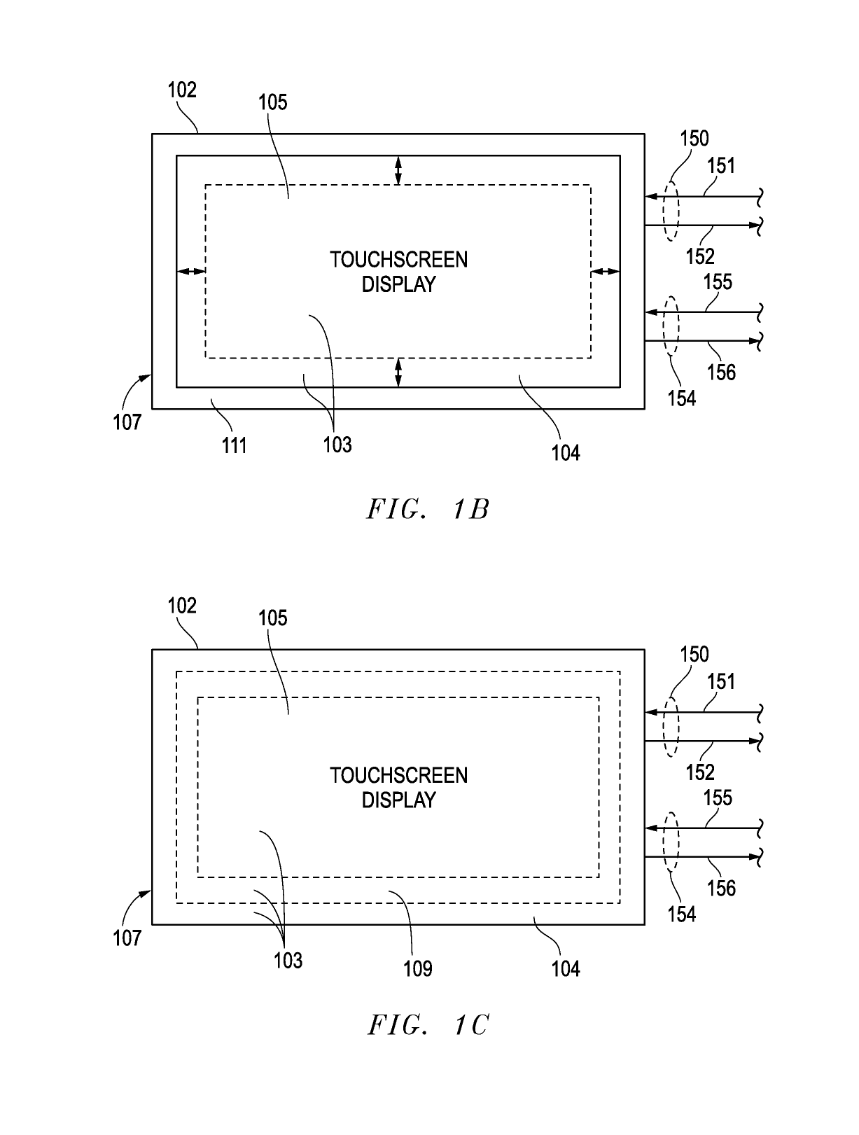

FIG. 1A illustrates one exemplary embodiment of an information handling system configured as a tablet computer system 100, although it will be understood that the disclosed systems and methods may be implemented with any other type of system having a touchscreen such as smart phone, convertible notebook computer, etc. As illustrated in FIG. 1A, tablet computer system 100 includes a touchscreen or touch-sensitive display 102 that is coupled via a video display processing device 116 (e.g., such as the illustrated video display controller or a video display processor, graphics processing unit, etc.) to a host processing device 106 (e.g., the illustrated central processing unit “CPU” or other suitable host processing device) that is configured to execute one or more software applications 114 and a tablet computer operating system (OS) 112 such as Microsoft Windows 8, Android, etc. As further illustrated, host processing device 106 is coupled to system storage 110 (hard disk drive, solid state drive “SSD”, etc.) where OS 112, application software 114 and data are stored. Host processing device 110 is also coupled to system memory 108 (e.g., random access memory) where OS 112 and applications 114 are loaded during system operation. Also illustrated in FIG. 1A are optional sound controller 120 that may be present to receive digital audio data 130 from OS 112 and to produce analog audio output 131 to speaker 122. As further shown, display controller 116 is coupled to non-volatile memory (NVM) 118 (e.g., non-volatile RAM or other suitable form of NVM memory) where firmware executed by display controller 116 is stored. Examples of touchscreen or touch-sensitive display methodology and circuit configurations may be found, for example, in United States Patent Application Publication Number 2014/0282228 and in United States Patent Application Publication Number 2014/0206416, each of which is incorporated herein by reference in its entirety for all purposes.

In the embodiment of FIG. 1A, touchscreen display 102 has a touch-sensing interactive UI area 103 that extends to the physical hardware edge 107 of the touchscreen display device 102, i.e., touchscreen display 102 is an edgeless device having pixels and touch-sensing circuitry (e.g., capacitance-sensing circuitry, resistance touch-sensing circuitry, etc.) that extend to the edge 107 of the touchscreen display 102 without the presence of a pixel-less non-interactive hardware frame area on any side. However, in other embodiments, a touchscreen display 102 may be employed that has an optional pixel-less non-interactive hardware frame area 111 where no pixels or touch-sensitive circuitry is present that surrounds interactive UI area 103 as illustrated in FIG. 1B. Such a pixel-less non-interactive hardware frame area 111 may be provided on one or more sides of the touchscreen display 102. In such an alternate embodiment illustrated in FIG. 1B, touch-sensing interactive UI area 103 extends to the edge of the hardware frame area 111, but does not extend to the physical hardware edge 107 of touchscreen display 102. A pixel-less non-interactive hardware frame area 111 may be of any suitable width, e.g., less than 2 centimeters in one embodiment. However, widths of pixel-less non-interactive hardware frame area 111 that are greater than or equal to 2 centimeters are also possible. In any case, an active user interface area 105 and virtual bezel area/s 104 as described further herein may be provided within the boundaries of an optional hardware frame area 111 (such as illustrated in FIG. 1B), or within the boundaries of the physical hardware edge 107 of the touchscreen display 102 where no hardware frame areal 111 is present.

Returning to FIG. 1A, a touch interpretative layer 117 may be implemented at least in part by display controller 116 and/or an optional co-processor 125 or other suitable processing device/s operatively coupled to display controller 116 and that is specialized in performing calculations for touch analysis. As further shown in the embodiment of FIG. 1A, touch analyzer logic 119 (e.g., software and/or firmware) may be provided as part of touch interpretative layer 117, and is configured to perform the touch analyzing features and tasks described herein for interpretative layer 117.

As shown in FIG. 1A, touch interpretative layer 117 is coupled to receive video pixel data 161 for an active user interface (UI) area 105 from OS 112 executing on host processing device 106 that corresponds, for example, to active UI video pixel data originated by application/s 114. Interpretative layer 117 of display controller is configured to in turn provide frame buffer video display data 151 or other suitable type of video display data for pixels of touchscreen display 102 to produce active UI area 105 as shown. In response to user touches to areas of UI active area 105, display controller also receives active UI touch input signals 152 (e.g., capacitance signals from capacitive touch circuitry, voltage signals from resistive touch circuitry, SAW signals from surface acoustic wave touch circuitry, etc.) from active UI area 105 of touchscreen 102, and provides corresponding touch input data 162 representative of the touched areas of UI area 105 to OS 112 executing on host processing device 106 as shown. Thus in FIG. 1A, interpretative layer 117 is configured to bi-directionally exchange UI pixel and touch input data 160 with host processing device 106 and to bi-directionally exchange corresponding active UI pixel display data and touch input signals 150 with touch screen display 102.

As further shown in FIG. 1A, touch interpretative layer 117 is coupled to receive video pixel data 165 from OS 112 executing on host processing device 106 that corresponds to one or more variable virtual bezel area/s 104 that are designated and controlled by touch interpretative layer 117. In this regard, touch interpretative layer 117 may be configured to assign the identity of designated areas of interactive area 103 of touchscreen 102 to signals and data 150 versus 154 (and to data 160 versus 164) in real time based on the current defined area of virtual bezel area/s 104 (and/or neutral area 109). As described further herein, video pixel data 165 corresponding to a currently designated virtual bezel area/s 104 may be processed by interpretative layer 117 of display controller 116 in a variety of manners. In one embodiment, video pixel data 165 may be combined with video pixel data 161 corresponding to a currently designated active UI area 105 so as to produce video display data 151 that represents an adjusted (e.g., scaled or unscaled) and downsized combined complete image that is completely displayed within active UI area 105 of touchscreen 102. In another embodiment, video pixel data 165 may be used to produce video display data 151 to display the image portions corresponding to video pixel data 165 in the area of a transparent virtual bezel area/s 104. In another embodiment, video pixel data 165 may be ignored where video display data 151 is produce to display an opaque (e.g., black) virtual bezel area/s 104, in which case the portion of an image corresponding to video pixel data 165 is not displayed.

In this embodiment, interpretative layer 117 is configured to interpret the use of touchscreen display 102 in real time and to control characteristic of the virtual bezel area/s 104 based on interpreted characteristics of a user's touch sensed via bezel area touch input signals 156 in a real time manner as described further herein. In particular, interpretative layer 117 is configured to provide frame buffer video display data 155 or other suitable type of video display data for appropriate pixels of touchscreen display 102 to selectably produce one or more variable-sized virtual bezel area/s 104 as shown based on interpreted characteristics of a user's touch. In this regard, interpretative layer 117 may in one embodiment be configured to provide display data 155 to produce a non-transparent (e.g., black) virtual bezel area 104 that obscures the graphic portions of a display area produced in the virtual bezel area 104 by operating system 112 and/or application/s 114 executing on host processing device 106, and in another embodiment to turn off the display pixels in virtual bezel area/s 104 (in which case no display data 155 is provided but touch input signals 156 are still produced from virtual bezel area/s 104) to produce a black bezel area/s 104 to save battery power consumption from the pixels of bezel area/s 104 and therefore increase energy efficiency and prolong battery working time. In another embodiment, interpretative layer 117 may provide display data 155 to produce a transparent virtual bezel area 104 (and/or alternatively neutral area 109 of FIG. 1C) that displays the graphic portions of a display area produced in the virtual bezel area 104 by operating system 112 and/or application/s 114 executing on host processing device 106. In either case, virtual bezel area/s 104 may be controlled by display controller 116 to be inactive touch areas with respect to the OS 112 and applications 114 executing on host processing device 106 as will be described further herein.

Still referring to FIG. 1A, interpretative layer 117 is also configured to receive touch input signals 156 (e.g., capacitance signals from capacitive touch circuitry, voltage signals from resistive touch circuitry, SAW signals from surface acoustic wave touch circuitry, etc.) from variable virtual bezel area/s 104 (and/or neutral area 109) of touchscreen 102, but as shown is configured to block or otherwise withhold or not provide corresponding touch input data 166 corresponding to current location of virtual bezel area/s 104 (and/or neutral area 109) to OS 112. Thus in FIG. 1A, interpretative layer 117 is configured to bi-directionally exchange active UI pixel display data (based on video pixel data 165) and touch input signals 154 with touchscreen display 102 (including receiving bezel touch input signals 156 from variable virtual bezel area/s 104 of touchscreen 102); but without providing any corresponding touch input data components 166 of bezel pixel data 164 to host processing device 106. In this way, interpretative layer 117 is configured to control virtual bezel area/s 104 based on characteristics of a user's touch input without providing any knowledge or awareness of the bezel area/s 104 to OS 112 and applications 114, and while at the same time making these virtual bezel area/s 104 inactive touch areas to OS 112 and applications 114 since OS 112 and applications 114 do not receive touch input corresponding to area/s 104. As illustrated in FIG. 1A, an optional hardware switch 123 coupled to interpretative layer 117 may be provided to allow a user to control switching between a virtual bezel mode and a bezel-less mode as described further herein.

In a further embodiment illustrated in FIG. 1C, an optional “neutral area” 109 may be defined as a transparent (i.e., transparent to a displayed image) but non-touch interactive virtual bezel area component (e.g., of about 0.5 to about 1 centimeter in width or other suitable greater or lesser value) which is positioned between active user interface area 105 and virtual bezel area/s 104 (e.g., bezel area/s 104 which may have switched-off display pixels). In such an alternative embodiment, neutral area 109 may be provided by interpretive layer 117 of display controller 116 as a partially or completely non-touch interactive virtual display area that may be invisible (e.g., transparent) to a user. For example, in one embodiment, interpretative layer 117 may block or otherwise exclude from processing by OS 112 and applications 114 any touch input data 166 that results from user touches to neutral area 109, except for touch input data 166 that results from particular pre-defined gestures (e.g., inward and/or outward slide gestures) that are recognized by interpretive layer 117. Examples of such pre-defined gestures may be inward sliding user touch gestures which start from any of the peripheral outside edges of virtual bezel 104 and move across virtual bezel 104 and neutral area 109 (and vice versa in outward manner), inward sliding user touch gestures which start from any of the peripheral outside edges of neutral area 109 (i.e., at the border with virtual bezel 104) across the neutral area 109 (and vice-versa in outward manner), etc. In another exemplary embodiment, interpretative layer 117 may block or otherwise exclude from processing by OS 112 and applications 114 all touch input data 166 that results from any type of user touches to neutral area 109.

In any case, such an optional neutral area 109 may be provided, for example, to reduce or prevent occasional accidental interaction of a user's gripping thumb with active user interface area 105 when the thumb goes beyond the internal edge of the non-transparent virtual bezel 104. In a further embodiment, the width of neutral area 109 may be manually defined/changed in system settings, in which users may be allowed to enter a zero setting which will effectively exclude the neutral area 109 from the display 102.

In yet another possible embodiment where no neutral area 109 is displayed, interpretative layer 117 may be configured to analyze all touches within active user interface area 105 that are near or within a specified threshold distance (e.g., within about 1 centimeter vicinity or other suitable greater or lesser distance) of boundary of non-transparent virtual bezel area 104. In this optional embodiment, if any touch input space (e.g., of any size) is determined by interpretative layer 117 to concern (e.g., encroach on or otherwise contact or overlay) an internal edge of the virtual bezel area 104, the touch input should be qualified as a gripping input and be excluded by interpretative layer 117 from processing by OS 112 and applications 114 by blocking corresponding touch input data 166 from processing by OS 112 and applications 114.

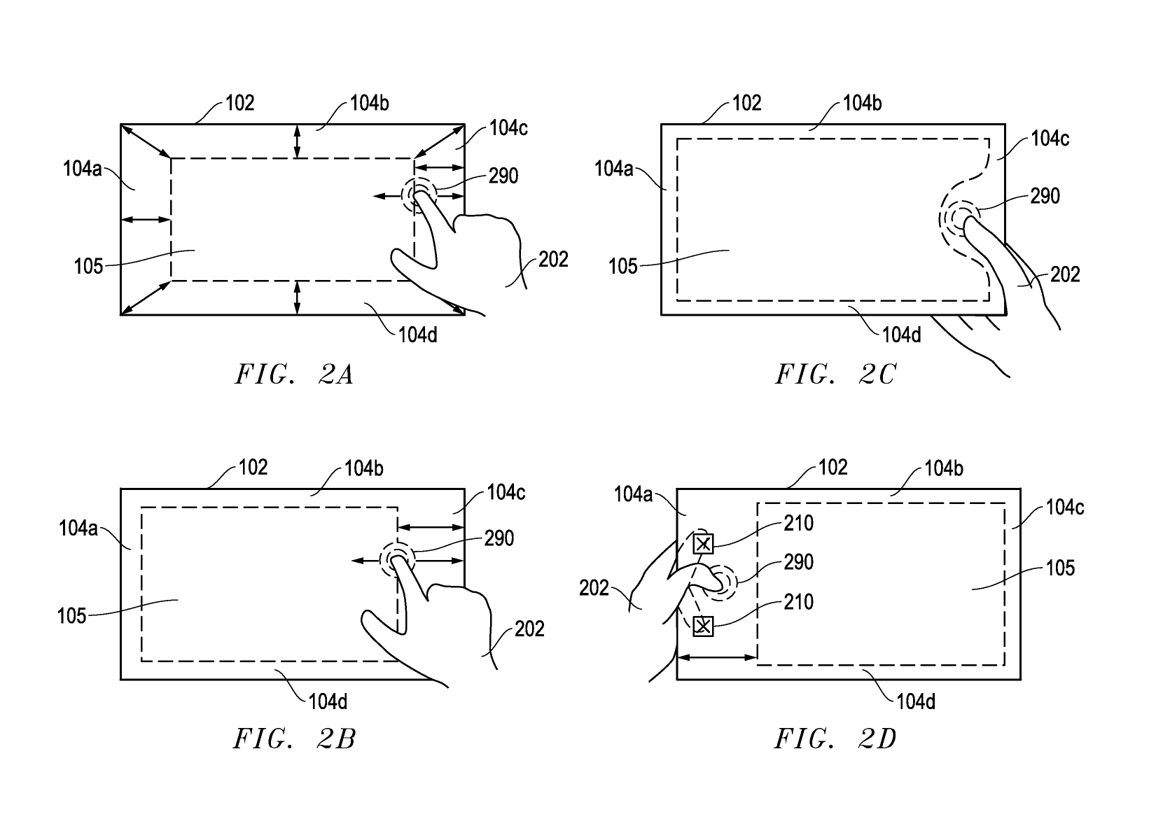

FIGS. 2A-2D illustrate various embodiments of virtual periphery control based on interpreted use of a touchscreen, e.g., such as a tablet computer, smart phone, etc. In this regard, FIGS. 2A-2D will be described with reference to the exemplary information handling system components of FIG. 1A, in which interpretative layer 117 senses pressure and/or location of a user's touch on screen 102 by touch input signals 152 and 156, and then selectively provides designated inactive virtual bezel area/s 104 by withholding touch input data 166 corresponding to all portions of the designated location/s of the virtual bezel area/s 104 from host processing device 106 and OS 112 (or in an alternate embodiment withholding touch input data 166 corresponding to selected portions of area 103 within the boundary of virtual bezel area/s 104 such as illustrated in FIG. 2D where touch input data 166 corresponding to areas 210 is provided to host processing device 106 and OS 112). However, it will be understood that other information handling system component configurations are possible.

It will be understood that in one embodiment, virtual bezel area/s 104 may be automatically activated and provided on a touchscreen 102 (e.g., such as virtual bezel area/s 104 of FIGS. 2A-2D) when interpretative layer 117 senses that a user has otherwise touched the screen 102 at a location encircled by circle 290 in a manner that meets predefined characteristics of a gripping input such as described elsewhere herein. Such a gripping input may correspond to holding the touchscreen display device on-the-go, when presenting or handing the touchscreen display device from one person to another person, when performing task-based grab actions (e.g., such as reading, games, etc.). In a further embodiment, such virtual bezel area/s 104 may be removed upon occurrence of a specified event/s, such as specified time period of inactivity where no user touch event is applied to touchscreen 102, upon input of user command to UI (e.g., button) of touchscreen 102, user activation of hardware switch 123 between virtual bezel mode to bezel-less mode, etc. In this regard, a hardware or UI switch may be provided to allow a user to switch at will between virtual bezel mode to bezel-less mode.

In the embodiment of FIG. 2A, width of all four peripheral virtual bezel area/s 104 may remain symmetric and may be modified together and simultaneously in a virtual bezel area resizing mode by action of a finger or thumb on a user's hand 202 as shown when interpretative layer 117 senses the presence of the user's finger or thumb applying a sustained resizing touching pressure to touch screen display 102 that meets or exceeds a higher pressure resizing mode threshold that represents a higher pressure than a normal fingertip pointing input pressure (e.g., such as greater than about 1.5 times or greater than about 2 times a normal fingertip pointing input pressure that is empirically determined based on actual measured user fingertip input pressure, or any other suitable minimum pressure threshold utilized by touchscreen operating systems to analyze fingertip or other types of gestures) at a sustained-touch location 290 for greater than a threshold resizing mode period of time (e.g., sustained higher pressure for greater than about 3 seconds). Values of such higher pressure and sustained pressure thresholds may in one exemplary embodiment be automatically pre-determined for, or voluntarily set by, each individual user during setup calibration. In another embodiment, such a virtual bezel area resizing mode may be entered when interpretative layer 117 senses that a user has otherwise touched the screen 102 at location 290 in a manner that meets predefined characteristics of a gripping input such as described elsewhere herein.

Still referring to FIG. 2A, interpretative layer 117 may be configured to respond to detection of such a sustained resizing mode touching pressure and/or a gripping input by entering a temporary virtual bezel area re-sizing mode, in which the interpretative layer 117 places a boundary defined by inactive virtual bezel area 104c at or adjacent the sustained-touch or gripping location 290 as shown together with other virtual bezel area boundaries 104a, 104b and 104d as shown. Interpretative layer 117 may further optionally be configured to then respond during the resizing mode to user gestures such as sensed sideways movement of the user's finger (e.g., via touch input signals 152 and/or 156) while in virtual bezel area re-sizing mode to expand or reduce the width of each of virtual bezel areas 104a, 104b, 104c, and 104d simultaneously with each other and in a like manner, or in a manner that is scaled relative to each other (e.g., to maintain the same aspect ratio for active UI area 105 as its size is changed). Thus, interpretative layer 117 may still track user touch events in inactive virtual bezel areas 104 via touch input signals 156, even when these signals are blocked from OS 112 and applications 114. It will be understood that in the embodiment of FIG. 2A, an image displayed in active UI area 105 may be adjusted as desired or needed to fit into a re-sized active UI area 105 (e.g., in a scaled manner where horizontal and vertical image dimensions are changed in proportion to each other, or in an unscaled manner where horizontal and vertical image dimensions are changed in non-proportional or slightly different proportions from each other), or such a displayed image may be partially overlapped and/or obscured by the re-sized virtual bezel 104 in a manner as described further herein.

Specifically, in the illustrated embodiment of FIG. 2A, interpretative layer 117 may be configured to respond to a leftward movement of the users right index finger in contact with screen 102 by simultaneously expanding the width of all four inactive virtual bezel areas 104a, 104b, 104c, and 104d; and conversely may be configured to respond to a rightward movement of the users right index finger in contact with screen 102 by simultaneously reducing the width of all four virtual bezel areas 104a, 104b, 104c, and 104d. However, scaled and/or simultaneous resizing of four virtual bezel areas is only exemplary. In other embodiments, interpretative layer 117 may be configured to allow only one virtual bezel area 104c to be similarly resized by itself at a time as shown in FIG. 2B, e.g., by placing and/or resizing a bezel area 104c in a position adjacent or at the finger or sustained-touch area 290 while the other bezel areas 104a, 104b and 104d remain fixed in width so as to produce an asymmetric virtual peripheral bezel. In other embodiments, any number of two or more bezel area/s 104 may be simultaneously resized together in a similar manner. It will also be understood that virtual bezel area/s 104 may be placed on only a portion of the peripheral sides of a display screen 102, e.g., so that no inactive virtual bezel area 104 may be present on any one or more other sides of the display screen 102. In any case, upon sensing that the sustained touching pressure or other type of gripping input event has ceased (e.g., the user has removed the touch), then interpretative layer 117 may be configured in one embodiment to exit the virtual bezel area re-sizing mode and leave the final location of the peripheral virtual bezel area/s 104 fixed, e.g., until another sustained touching pressure or other type of gripping input event is detected and interpretative layer 117 enters the virtual bezel area re-sizing mode again in similar manner. It will also be understood that a hardware bezel control button may be provided to allow a user to activate manual adjustment of virtual bezel area/s 104 in manner similar to that described for any of FIGS. 2A-2D by using the user's finger to long-press (e.g., for predefined minimum threshold time) the bezel control button. Such a hardware bezel control button may also be provided to allow a user to cause the touchscreen display 102 to transition from bezel-less mode to virtual bezel mode (and vice-versa), e.g., by shorter time length press of the bezel control button (e.g., for a press time less than the predefined minimum threshold time).

In an alternative embodiment, any one or more of peripheral virtual bezel area/s 104 may be automatically activated by interpretative layer 117 with a predefined fixed numerical width (e.g., such as 2 centimeters or other suitable greater or lesser width set in system BIOS or tablet settings during first system boot) when interpretative layer 117 senses the presence of the user's finger or thumb applying a sustained higher finger pressure for greater than a minimum threshold amount of time at a sustained-touch location 290, or senses that a user has otherwise touched the screen 102 at location 290 in a manner that meets predefined characteristics of a gripping input such as described elsewhere herein. In such an alternative embodiment, interpretative layer 117 may be configured to then optionally allow the established fixed-width virtual peripheral virtual bezel area/s 104 to be resized by a user in the manner described in relation to FIGS. 2A and 2B, or alternatively may not allow a user to resize the fixed-width virtual peripheral virtual bezel area/s 104 once they have been so established. In yet another alternative embodiment, when an application 114 and/or OS 112 goes into full-screen mode (e.g., such as automatically when placed in a keyboard docking station or hardware keyboard, or switched off by a user via user input to touchscreen UI, when running full-screen applications, when using the touchscreen display as a photo or video frame, etc.), all virtual bezel area/s 104 may be switched off to provide a bezel-less display on touchscreen 102, i.e., that is a completely active UI. In one exemplary embodiment, an accelerometer may be integrated within system 100 to sense when a current position of the touchscreen display 102 has not changed for a predefined minimum threshold period of time (e.g., such as when used as a photo or video frame, daydream, for car navigation, etc.)

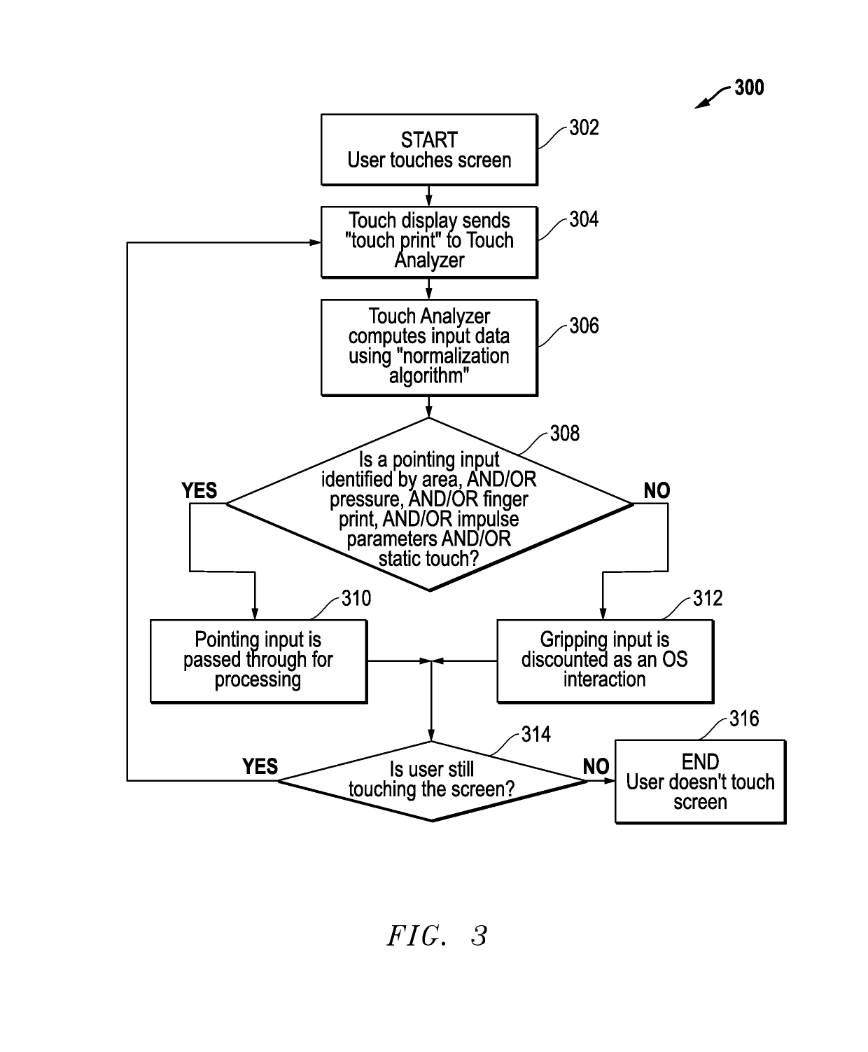

FIG. 2C illustrates another exemplary embodiment in which an interpretative layer 117 may be configured to respond to an interpreted gripping input that is sensed at an identified gripping location 290 by automatically placing an inactive virtual bezel area 104c having a “liquid edge” or flexible boundary that flows around or selectively bypasses (e.g., in a manner that closely follows) the periphery of the currently identified and located gripping area location 290 so as to place only the immediate vicinity of the sustained-touch or gripping location 290 within the inactive virtual bezel area 104c as shown in FIG. 2C. A gripping input at a gripping location 290 may be directly identified by interpretative layer 117 based on characteristics of minimum surface area, minimum pressure and/or shape of a touch print. However, in another exemplary embodiment described in relation to FIG. 3, interpretative layer 117 may indirectly identify a gripping input at a gripping location 290 by first analyzing a touch print received from display 102 for characteristics of a finger touch input that, where found to exist, is to be passed to OS 112 and/or applications 114. Where a touch does not meet the characteristics of such a finger touch input, then interpretative layer 117 may identify the touch as a gripping input at a gripping area location 290. In an alternative embodiment, only the actual surface area (e.g., user thumb touch area or user palm touch area) of the sustained-touch or gripping location 290 may be treated by interpretative layer 117 as an inactive virtual bezel area 104, with all other areas of touchscreen 102 treated and processed by interpretative layer 117 as being an active UI area 105.

As previously described, interpretative layer 117 may be configured to block touch input data 166 corresponding to the pixels of the current location of the virtual bezel area 104c, and virtual bezel area 104c may be transparent or non-transparent. In any event, the selective placement of an inactive virtual bezel area 104c having a flexible boundary may be utilized to maximize the remaining area of active UI area 105 since the surface area of inactive virtual bezel area 104c is minimized in this embodiment. In the embodiment of FIG. 2C, the size and shape of the liquid virtual bezel area 104c may be set and maintained in any suitable manner, e.g., by a defined distance as measured inward to screen 102 from the location 290, by a defined surface area established around the location 290, etc. In one embodiment, interpretative layer 117 may be configured to re-size and/or re-shape the flexible boundary of an inactive virtual bezel 104 on the fly and in real time to continuously follow changes in location, shape and/or surface area of sensed sustained-touch or gripping location 290. In one exemplary embodiment, a flexible boundary of an inactive virtual bezel 104 may be localized to the gripping touch location 290 (e.g., defined to encircle the touch location 290 by a minimum spacing such as 0.5 centimeter or other suitable value).

FIG. 2D illustrates another exemplary embodiment in which an interpretative layer 117 may be configured to respond to an interpreted gripping input that is sensed at an identified sustained-touch or gripping location 290 by automatically placing one or more special purpose virtual active user interface (UI) areas (e.g., virtual hot buttons) 210 that are embedded within an inactive virtual bezel area 104a around the currently-identified location 290 of a sustained-touch or gripping area. In this regard, location of virtual active UI area/s 210 may be automatically selected to be placed within a given offset distance and/or direction of the sustained-touch or gripping location 290, e.g., above or below the location 290 and positioned slightly outward toward the edge of the display screen 102 so as to facilitate ease of touch by a pivoting thumb of hand 202 that is currently gripping the sustained-touch screen 202 at the location 290. It will be understood that in a further embodiment interpretative layer 117 may be configured to automatically change the location of virtual active UI area/s 210 in real time to follow changes in location of sustained-touch or gripping location 290.

Still referring to the exemplary embodiment of FIG. 2D, interpretative layer 117 may be configured to provide frame buffer video display data 155 for appropriate pixels of touchscreen display 102 to selectably produce one or more virtual active UI areas 210 that are mapped to particular defined functions, e.g. of OS 112 or applications 114. In such an embodiment, interpretative layer 117 may be configured to block touch input data 166 corresponding to the bezel area touch input signals 156 received from the pixels of a virtual bezel area 104a (which may be provided, for example, according to any of the embodiments described above with regard to FIG. 2A, 2B or 2C), while at the same time accepting and selectively providing touch input data 166 to OS 112 that corresponds to touch input signals 156 received from the pixels of virtual active UI areas 210 located within the periphery of inactive virtual area 104a. In this regard interpretative layer 117 may be configured to map one or more virtual active UI areas 210 to a particular function (e.g., camera shutter button, scan button, shoot to web button, display contrast button, audio volume button, etc.) of a given application 114 executing on host processing device 106, e.g., without knowledge or awareness of application 114. Thus touch events and active areas may be hosted within an inactive virtual bezel area 104 via interpretative layer 117.

As further shown, interpretative layer 117 may be configured to automatically accommodate and adjust for a sustained-touch or gripping location 290 produced by a right-handed grip (e.g., underhanded right-hand grip such as shown in FIG. 2C) or left-handed grip (e.g., overhanded left-hand grip such as shown in FIG. 2D).

FIG. 3 illustrates one exemplary embodiment of a methodology 300 that may be employed by touch interpretive layer 117 to distinguish between a pointing input event (e.g., such as fingertip touch and/or knuckle touch) applied by a user to interactive UI active area 105 of touchscreen 102 (i.e., and that is accordingly passed through to OS 112 and applications 114) and a gripping input event applied to a gripping area 290 and that is interpreted as a virtual bezel area 104 of touchscreen 102 and therefore blocked from OS 112 and applications 114. Although described in relation to the exemplary embodiment of information handling system 100 of FIG. 1A, it will be understood that methodology 300 may be implemented by any other touchscreen system configuration.

Still referring to FIG. 3, methodology 300 starts in step 302 with a touch event where a portion of a user's hand 202 (e.g., fingertip, knuckle, thumb, palm, etc.) touches the touchscreen 302 while the information handling system 100 is powered up. In step 304, touch input signals (e.g., capacitive and/or resistive signals) are provided as a “touch print” from touch screen 102 to touch analyzer logic implemented by touch interpretative layer 117. This touch print may include information related to one or more characteristics of the touch event, e.g., such as touch input surface area, biometrics (e.g., such as finger print pattern, etc.) and/or impulse parameters (e.g., such as trembling pattern, heartbeat, etc.), etc. Then in step 306, the touch analyzer logic first optionally computes input data using a normalization algorithm executed by interpretative layer 117 which may be configured to calculate or otherwise determine touch parameter/s for each touch event, such as calculating touch surface area, calculating uninterrupted time duration of a static touch event, reading fingerprint patterns and creating their hashes, analyzing strength and amplitude of trembling associated with the touch event, recognizing unique heartbeat patterns to identify each individual different user (e.g., since fingertip touch surface areas may be different for different users), etc. The touch parameter/s of the touch print normalization algorithm are then further analyzed by touch analyzer logic 119 of interpretative layer 117 in step 308 to determine if the current touch event is a pointing event (e.g., by fingertip or knuckle) or corresponds to a gripping touch event (e.g., by thumb or palm).

For example, in one embodiment touch analyzer logic of interpretative layer 117 may be configured determine if the touch print of the touch event exceeds a pre-defined maximum fingertip input surface area, in which case the touch event is interpreted as a gripping input event (e.g., by a user's thumb or portion of the user's palm) rather than fingertip input event (otherwise, the touch event is characterized as a pointing event). In another exemplary embodiment, touch analyzer logic of interpretative layer 117 may be configured to determine if impulse characteristics correspond to a pointing input event or even a particular type of pointing input event (e.g., predefined user trembling pattern corresponding to a user knuckle touch rather than other type of trembling pattern that corresponds to a user fingertip touch, etc.). In another embodiment, touch analyzer logic of interpretative layer 117 may be configured to determine if touch print pressure (e.g., weight per surface area) applied to the touchscreen 102 exceeds a maximum pressure level applied to the touchscreen 102, in which case the touch event is interpreted as a gripping input event (otherwise the touch event is characterized as a pointing event). In yet another exemplary embodiment, biometric parameters of the touch print (e.g., such as fingerprint pattern, etc.) may be analyzed to distinguish between a pointing input event and a gripping input event, or even to distinguish a particular type of pointing event (e.g., knuckle versus fingertip). As previously described, since fingertips and corresponding fingertip touch areas of different users vary in their size, in another exemplary embodiment, touch analyzer logic 119 of interpretative layer 117 may determine unique heartbeats corresponding to fingertip touches of each individual (user) using the information handing system (e.g., such as tablet computer).

In yet another exemplary embodiment, touch analyzer logic of interpretative layer 117 may be configured to determine the uninterrupted duration of a static touch event or a substantially static touch event (e.g., a current touch event with substantially no movement, changes and/or other dynamics that exceed a pre-defined and/or accuracy-limited movement detection threshold). In such an embodiment, all uninterrupted substantially static touch events that exceed a predefined static touch duration (e.g., threshold of about 5 seconds or any other suitable greater or lesser predefined time duration threshold) may be interpreted as a gripping input event, with corresponding touch input data 166 excluded from processing by OS 112 and applications 114.

It will be understood that the preceding examples of types of touch print characteristics that may be analyzed to distinguish between a pointing input event and a gripping input event are exemplary only, and that any other type/s of touch print characteristics may be similarly analyzed in step 308 that are suitable for distinguishing between a pointing input event and a gripping input event. Further, it will be understood that any combination of two or more types of touch print characteristics (e.g., including combinations of two or more off those touch print characteristics described above in relation to step 308) may be analyzed together to distinguish between a pointing input event and a gripping input event, e.g., such as requiring two or more pre-defined types of gripping input event touch print characteristics to be determined as being present before characterizing a particular touch print as a gripping input, or vice versa (requiring two or more pre-defined touching input event touch print characteristics to be determined as being present before characterizing a particular touch print as a gripping input). Moreover, a pointing input event of step 308 may be defined to only include identified fingertip touch events, to only include identified knuckle touch events, or may be defined to include either one of identified fingertip and knuckle touch events. Thus, touch print characteristics of a pointing input event and/or a gripping input event may be defined as desired or needed to include those particular types of touch print characteristics suited for a given application.

Returning to FIG. 3, methodology 300 proceeds from step 308 to step 310 when the current touch event is interpreted by interpretive layer 117 of display controller 116 as a pointing input event, and its corresponding touch input data 162 is then passed by display controller 116 through to OS 112 and/or applications 114 executing on host processing device 106. Methodology 300 then proceeds to step 314, where interpretive layer 117 of display controller 116 determines whether a touch event continues (user continues touching the screen) and, if so, then methodology 300 returns to step 304 and repeats. However, if in step 314 it is determined that a touch event is no longer present, then methodology 300 proceeds to step 316 where methodology ends until a new touch event is once again detected, and methodology 300 starts again in step 302. On the other hand, if in step 308, the current touch event is interpreted by interpretive layer 117 of display controller 116 as a gripping input event, then methodology 300 proceeds to step 312 where the touch input data 166 is discounted as an OS interaction and therefore blocked by display controller 116 through from OS 112 and applications 114 executing on host processing device 106, e.g., to produce a liquid virtual bezel effect such as described in relation to FIG. 2C, or to only block the touch input data 166 corresponding to only the actual area of the touch print that is identified as a gripping input. Then methodology 300 proceeds from step 312 to step 314 which is then performed as described above.

It will be understood that the particular steps of methodology 300 are exemplary only, and that any combination of fewer, additional and/or alternative steps may be performed that are suitable for accomplishing one of more of the tasks or functions described herein. For example, in one alternative embodiment step 312 may be followed by using the identified gripping input event of step 312 that is applied to a gripping area 290 to accomplish the virtual peripheral control features described above in relation to FIGS. 2A-2D.

In another exemplary embodiment, an application programming interface (API) may be provided to implement virtual bezel control functionality in third-party applications 114, e.g., such as to customize size of virtual bezel area/s 104 on the application level, adjust bezel configuration, etc. Additionally, a custom API may also be provided for third-party applications 114 to allow them to implement their own special purpose virtual active user interface (UI) areas (e.g., virtual hot buttons) 210 that are embedded within an inactive virtual bezel area 104 in a manner similar to that described in relation to FIG. 2D. In a further embodiment, each application vendor may be allowed to specify what parts of an application UI should be interactive, if they need to be semi-transparent or non-transparent, and/or if the application may be capable to enter/exit full screen mode with a help of virtual button. In such a case, an API may be provided to allow third-party developers with capabilities (commands/scripts) to create such types of applications 114.

In another embodiment, when an application 114 is launched in full-screen mode, it may be presented as a non-interactive area all over the touchscreen 102. In such a case, the application 114 may display a screen note on touchscreen 102 that explains how a user can interact with the application and inviting the user to make a finger slide or other specified gesture to start the application 114 in interactive mode. As soon as the specified gesture (e.g., slide gesture) is performed by the user, the application 114 may be configured to make some parts of the touchscreen 102 into an active UI area 105 and/or into another type of active UI area (e.g., such as special purpose active UI button 210), whereas other areas of the touchscreen 102 are left as non-interactive areas that are treated in a similar manner as described herein for virtual bezel area/s 104. For example, in a movie player application, only play/stop/pause and fast forward/back buttons 210 may be interactive whereas all other areas of the touchscreen 102 are non-interactive for finger touches. In another embodiment, such as a mapping application, a semi or almost-transparent non-interactive peripheral virtual bezel area 104 may be created whereas all central areas of the touchscreen 102 may be an interactive UI area 105. In yet another embodiment (e.g., such as an aircraft simulator game application 114), interactive UI buttons 210 may only be provided on the left and right edges of the touchscreen 102, whereas all other areas of the touchscreen 102 may be non-interactive.

It will be understood that one or more of the tasks, functions, or methodologies described herein (e.g., including those described herein for display controller 116, touch interpretative layer 117, touch analysis co-processor, host processing device 106 etc.) may be implemented by circuitry and/or by a computer program of instructions (e.g., computer readable code such as firmware code or software code) embodied in a non-transitory tangible computer readable medium (e.g., optical disk, magnetic disk, non-volatile memory device, etc.), in which the computer program comprising instructions are configured when executed (e.g., executed on a processing device of an information handling system such as CPU, controller, microcontroller, processor, microprocessor, FPGA, ASIC, PLD, CPLD or other suitable processing device) to perform one or more steps of the methodologies disclosed herein. A computer program of instructions may be stored in or on the non-transitory computer-readable medium accessible by an information handling system for instructing the information handling system to execute the computer program of instructions. The computer program of instructions may include an ordered listing of executable instructions for implementing logical functions in the information handling system. The executable instructions may comprise a plurality of code segments operable to instruct the information handling system to perform the methodology disclosed herein. It will also be understood that one or more steps of the present methodologies may be employed in one or more code segments of the computer program. For example, a code segment executed by the information handling system may include one or more steps of the disclosed methodologies.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touch screen and/or a video display. The information handling system may also include one or more buses operable to transmit communications between the various hardware components.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

What is claimed is:

1. An information handling system, comprising:
at least one host processing device configured to produce video pixel data;
a touchscreen display having an interactive user interface area configured to display images based on video display data and to produce touch input signals corresponding to areas of the interactive user interface that are touched by a user; and
at least one second processing device coupled between the host processing device and the touchscreen display and configured to receive the video pixel data from the host processing device and to receive the touch input signals from the interactive user interface area of the touchscreen display, the second processing device being further configured to provide video display data to the touchscreen display that is based on the video pixel data received from the host processing device and to provide touch input data to the host processing device that is based on the touch input signals received from the touch screen;
where the second processing device is configured to:
segregate the interactive user interface area of the touchscreen display into at least one active user interface area and at least one separate virtual bezel area,
receive touch input signals from the active user interface area and provide touch input data to the host processing device corresponding to touch input signals received from the touchscreen display that are representative of touched areas of the active user interface area, and
receive touch input signals from the virtual bezel area and block touch input data to the host processing device corresponding to touch input signals received from the touchscreen display that are representative of touched areas of the virtual bezel area.

2. The system of claim 1, where the second processing device is further configured to produce at least one of a transparent virtual bezel area or transparent neutral area by providing video display data to the touchscreen display to produce a displayed image in the virtual bezel area or neutral area that is based on the video pixel data corresponding to the virtual bezel area or neutral area that is received from the host processing device.

3. The system of claim 1, where the second processing device is further configured to produce an opaque virtual bezel area by providing video display data to the touchscreen display to produce an opaque image in the virtual bezel area rather than an image that is based on the video pixel data corresponding to the virtual bezel area that is received from the host processing device.

4. The system of claim 1, where the second processing device is further configured to produce an opaque virtual bezel area by turning off display pixels in the area of the virtual bezel area.

5. The system of claim 1, where the second processing device is further configured to combine the video pixel data received from the host processing device that corresponds to a portion of an image to be displayed in the virtual bezel area with the video pixel data that is received from the host processing device that corresponds to a portion an image to be displayed in the active user interface area to produce combined video display data; and to provide the combined video display data to the touchscreen display to produce an adjusted combined image that is displayed entirely in the active user interface area of the touchscreen display and not displayed in the virtual bezel area of the touchscreen display.

6. The system of claim 1, where the second processing device is further configured to:
provide video display data to the virtual bezel area of the touchscreen display to display one or more selected special purpose virtual active user interface (UI) areas within boundaries of the virtual bezel area;
receive touch input signals corresponding to the location of the selected special purpose virtual active user interface (UI) areas displayed on the touchscreen display; and
provide touch input data to the host processing device corresponding to the touch input signals received from the location of the displayed selected special purpose virtual active user interface (UI) areas and block touch input data to the host processing device corresponding to touch input signals received from the touchscreen display that correspond to all locations within the boundary of the displayed virtual bezel area other than the displayed locations of the special purpose virtual active user interface (UI) areas.

7. The system of claim 1, where the second processing device is further configured to:
analyze one or more touch parameters of the received touch input signals corresponding to one or more areas of the interactive user interface that are touched by a user during a touch event to determine if the current touch event is a pointing event or is a gripping touch event; and
then provide the received touch input signals of the touch event as touch input data representative of the touched areas of the interactive user interface to the host processing device if the current touch event is determined to be a pointing event, or not provide the received touch input signals of the touch event as touch input data representative of the touched areas of the interactive user interface to the host processing device if the current touch event is determined to be a gripping input event.

8. The system of claim 7, where the analyzed touch parameters of the touch event comprise a determined surface area of a touch print associated with the touch event; and where the second processing device is further configured to determine that the current touch event is a gripping input event if the determined surface area of the touch print exceeds a pre-defined maximum fingertip input surface area, or to determine that the current touch event is a touching event if the determined surface area of the touch print does not exceed the pre-defined maximum fingertip input surface area.

9. The system of claim 7, where the second processing device is further configured to automatically segregate the interactive user interface area of the touchscreen display into the at least one active user interface area and the at least one separate virtual bezel area if the current touch event is determined to be a gripping input event, the virtual bezel area encompassing at least the touched areas of the interactive user interface that are determined to correspond to a gripping input event.

10. The system of claim 9, where the second processing device is further configured to automatically place the virtual bezel area to selectively bypass around a periphery of the area of the interactive user interface area of the touchscreen display corresponding to the touched areas of the interactive user interface that are determined to correspond to the gripping input event.

11. The system of claim 1, where the second processing device is further configured to enter a resizing mode upon detection of touch input signals received from the virtual bezel area that correspond to a sustained resizing mode touching pressure applied by a user to the interactive user interface area of the touchscreen display that meets or exceeds a predefined resizing pressure threshold for a period of time that exceeds a predefined resizing mode time threshold; and to then resize the virtual bezel area during the relative to the active user interface area during the resizing mode based on a user touch input gesture applied to the interactive user interface area of the touchscreen display.

12. A method, comprising:
displaying images based on video display data on a touchscreen display having an interactive user interface area, and producing touch input signals corresponding to areas of the interactive user interface that are touched by a user;
producing video pixel data from at least one host processing device;
receiving the video pixel data from the host processing device in at least one second processing device and receiving the touch input signals in the at least one second processing device from the interactive user interface area of the touchscreen display;
using the second processing device to provide video display data to the touchscreen display that is based on the video pixel data received from the host processing device and to provide touch input data to the host processing device that is based on the touch input signals received from the touch screen; and
using the second processing device to:
segregate the interactive user interface area of the touchscreen display into at least one active user interface area and at least one separate virtual bezel area,
receive touch input signals from the active user interface area and provide touch input data to the host processing device corresponding to touch input signals received from the touchscreen display that are representative of touched areas of the active user interface area, and
receive touch input signals from the virtual bezel area and block touch input data to the host processing device corresponding to touch input signals received from the touchscreen display that are representative of touched areas of the virtual bezel area.

13. The method of claim 12, further comprising using the second processing device to produce at least one of a transparent virtual bezel area or transparent neutral area by providing video display data to the touchscreen display to produce a displayed image in the virtual bezel area or neutral area that is based on the video pixel data corresponding to the virtual bezel area or neutral area that is received from the host processing device.

14. The method of claim 12, further comprising using the second processing device to produce an opaque virtual bezel area by providing video display data to the touchscreen display to produce an opaque image in the virtual bezel area rather than an image that is based on the video pixel data corresponding to the virtual bezel area that is received from the host processing device.

15. The method of claim 12, further comprising using the second processing device to produce an opaque virtual bezel area by turning off display pixels in the area of the virtual bezel area.

16. The method of claim 12, further comprising using the second processing device to combine the video pixel data received from the host processing device that corresponds to a portion of an image to be displayed in the virtual bezel area with the video pixel data that is received from the host processing device that corresponds to a portion an image to be displayed in the active user interface area to produce combined video display data; and to provide the combined video display data to the touchscreen display to produce an adjusted combined image that is displayed entirely in the active user interface area of the touchscreen display and not displayed in the virtual bezel area of the touchscreen display.

17. The method of claim 12, further comprising using the second processing device to:
provide video display data to the virtual bezel area of the touchscreen display to display one or more selected special purpose virtual active user interface (UI) areas within boundaries of the virtual bezel area;
receive touch input signals corresponding to the location of the selected special purpose virtual active user interface (UI) areas displayed on the touchscreen display; and
provide touch input data to the host processing device corresponding to the touch input signals received from the location of the displayed selected special purpose virtual active user interface (UI) areas and block touch input data to the host processing device corresponding to touch input signals received from the touchscreen display that correspond to all locations within the boundary of the displayed virtual bezel area other than the displayed locations of the special purpose virtual active user interface (UI) areas.

18. The method of claim 12, further comprising using the second processing device to:
analyze one or more touch parameters of the received touch input signals corresponding to one or more areas of the interactive user interface that are touched by a user during a touch event to determine if the current touch event is a pointing event or is a gripping touch event; and
then provide the received touch input signals of the touch event as touch input data representative of the touched areas of the interactive user interface to the host processing device if the current touch event is determined to be a pointing event, or not provide the received touch input signals of the touch event as touch input data representative of the touched areas of the interactive user interface to the host processing device if the current touch event is determined to be a gripping input event.

19. The method of claim 18, where the analyzed touch parameters of the touch event comprise a determined surface area of a touch print associated with the touch event; and further comprising using the second processing device to determine that the current touch event is a gripping input event if the determined surface area of the touch print exceeds a pre-defined maximum fingertip input surface area, or to determine that the current touch event is a touching event if the determined surface area of the touch print does not exceed the pre-defined maximum fingertip input surface area.

20. The method of claim 18, further comprising using the second processing device to automatically segregate the interactive user interface area of the touchscreen display into the at least one active user interface area and the at least one separate virtual bezel area if the current touch event is determined to be a gripping input event, the virtual bezel area encompassing at least the touched areas of the interactive user interface that are determined to correspond to a gripping input event.

21. The method of claim 20, further comprising using the second processing device to automatically place the virtual bezel area to selectively bypass around a periphery of the area of the interactive user interface area of the touchscreen display corresponding to the touched areas of the interactive user interface that are determined to correspond to the gripping input event.

22. The method of claim 12, further comprising using the second processing device to enter a resizing mode upon detection of touch input signals received from the virtual bezel area that correspond to a sustained resizing mode touching pressure applied by a user to the interactive user interface area of the touchscreen display that meets or exceeds a predefined resizing pressure threshold for a period of time that exceeds a predefined resizing mode time threshold; and to then resize the virtual bezel area during the relative to the active user interface area during the resizing mode based on a user touch input gesture applied to the interactive user interface area of the touchscreen display.
